(19) United States
(12) Patent Application Publication
(10) Pub. No.: US 2009/0309976 A1
(43) Pub. Date: Dec. 17, 2009

(54) System, Method and Computer Readable Medium for Determining an Informational Property of Wayside Equipment Adjacent to a Route

(76) Inventor: Ajith Kuttannair Kumar, Erie, PA (US)

Correspondence Address: BEUSSE WOLTER SANKS MORA & MAIRE, P.A., 390 NORTH ORANGE AVENUE, SUITE 2500, ORLANDO, FL, 32801, US

(21) Appl. No.: 12/137,152

(22) Filed: Jun. 11, 2008

(51) Int. Cl. H04N 7/18

(52) U.S. Cl. 348/161; 348/E07.085

(57) ABSTRACT

A system is provided for determining an informational property of wayside equipment adjacent to a route. The system includes a camera to collect visible spectral data of the wayside equipment. The camera is attached to a powered system traveling along the route. The system includes at least one filter to filter a known portion of the visible spectral data based upon known filter properties. The system further includes a controller coupled to the camera, to compare unfiltered visible spectral data with the filtered visible spectral data, in conjunction with the known properties of the filter, to determine the informational property of the wayside equipment. The unfiltered visible spectral data includes the data collected by the camera prior to the at least one filter being applied to the camera. Additionally, a method and computer readable medium are provided for determining an informational property of wayside equipment adjacent to a route.

### BACKGROUND OF THE INVENTION

In conventional locomotive imaging systems, cameras collect video information of the locomotive or surrounding railroad system, which is then typically stored in a memory of a processor. For example, such collected video information may include a railroad signal image collected from a railroad signal positioned adjacent to a railroad track. The processor may attempt to determine the color of the railroad signal, for purposes of controlling the operation of the locomotive, such as determining whether to continue along a portion of the railroad track, for example.

These conventional locomotive imaging systems may have complex recognition software and/or hardware to determine whether a collected image of a railroad signal is a particular color, such as infrared sensors, for example. Such systems have unique shortcomings, both in the complexity and the cost of the systems. Thus, it would be advantageous to provide a more simplistic and cost effective, yet equally effective system to assist in color recognition of railroad signals.

### BRIEF DESCRIPTION OF THE INVENTION

One embodiment of the present invention provides a system for determining an informational property of wayside equipment adjacent to a route. The system includes a camera configured to collect visible spectral data of the wayside equipment. The camera is attached to a powered system traveling along the route. The system includes at least one filter configured to filter a known portion of the visible spectral data based upon known properties of the filter. The system further includes a controller coupled to the camera. The controller is configured to compare unfiltered visible spectral data with the filtered visible spectral data, in conjunction with the known properties of the filter, to determine the informational property of the wayside equipment. The unfiltered visible spectral data includes the data collected by the camera prior to the at least one filter being applied to the camera.

Another embodiment of the present invention provides a method for determining an informational property of wayside equipment adjacent to a route. The method includes collecting visible spectral data of the wayside equipment with a camera attached to a powered system traveling along the route. The method further includes filtering a known portion of the visible spectral data based upon known properties of at least one filter. The method further includes comparing unfiltered visible spectral data with the filtered visible spectral data in conjunction with the known properties of the filter to determine the informational property of the wayside equipment. The unfiltered visible spectral data includes at least part of the visible spectral data collected by the camera prior to the filtering.

Another embodiment of the present invention provides computer readable medium for determining an informational property of wayside equipment adjacent to a route. The computer readable medium includes computer program code that when executed by a controller causes the controller to receive visible spectral data of wayside equipment collected by a camera attached to a powered system traveling along the route. The camera is connected to the controller, such that a known portion of the visible spectral data is filtered based upon known properties of at least one filter and at least part of the collected visible spectral data is maintained as unfiltered data. Additionally, the computer readable medium includes computer program code that when executed by the controller causes the controller to compare the unfiltered visible spectral data with the filtered visible spectral, in conjunction with the known properties of the filter, to determine the informational property of the wayside equipment.

### BRIEF DESCRIPTION OF THE DRAWINGS

A more particular description of the embodiments of the invention briefly described above will be rendered by reference to specific embodiments thereof that are illustrated in the appended drawings. Understanding that these drawings depict only typical embodiments of the invention and are not therefore to be considered to be limiting of its scope, the embodiments of the invention will be described and explained with additional specificity and detail through the use of the accompanying drawings in which:

FIG. 1 is a side view of a locomotive within a system for processing images of wayside equipment, according to an exemplary embodiment of the present invention;

FIG. 2 is a side view of an exemplary embodiment of a locomotive within the system for processing images of wayside equipment illustrated in FIG. 1;

FIG. 3 is a schematic view of an exemplary embodiment of a system for processing images of wayside equipment according to the present invention;

FIG. 4 is a plan view of a display from the system for processing images of wayside equipment illustrated in FIG. 1;

FIG. 5 is a top view of an exemplary embodiment of a locomotive within the system for processing images of wayside equipment illustrated in FIG. 1;

FIG. 6 is a flow chart illustrating an exemplary embodiment of a method for processing images of wayside equipment according to the present invention;

FIG. 7 is a side view of a locomotive within a system for determining an informational property of wayside equipment adjacent to a railroad, according to an exemplary embodiment of the present invention;

FIG. 8 is a side view of an exemplary embodiment of a locomotive within the system for determining an informational property of wayside equipment adjacent to a railroad illustrated in FIG. 7;

FIG. 9 is a schematic view of an exemplary embodiment of a system for determining an informational property of wayside equipment adjacent to a railroad according to the present invention;

FIG. 10 is a front plan view of an exemplary embodiment of a monitor illustrating unfiltered spectral data from the wayside equipment illustrated in FIG. 8;

FIG. 11 is a front plan view of an exemplary embodiment of a monitor illustrating filtered spectral data from the wayside equipment illustrated in FIG. 8;

FIG. 12 is a plot of an exemplary embodiment of the intensity versus the spectral wavelength for the unfiltered spectral data illustrated in FIG. 10;

FIG. 13 is a plot of an exemplary embodiment of the intensity versus the spectral wavelength of filtered spectral data of FIG. 12 passed through one filter;

FIG. 14 is a plot of an exemplary embodiment of the intensity versus the spectral wavelength of filtered spectral data of FIG. 12 passed through two filters; and

FIG. 15 is a flow chart illustrating an exemplary embodiment of a method for determining an informational property of wayside equipment adjacent to a railroad according to the present invention.

### DETAILED DESCRIPTION OF THE INVENTION

In describing particular features of different embodiments of the present invention, number references will be utilized in relation to the figures accompanying the specification. Similar or identical number references in different figures may be utilized to indicate similar or identical components among different embodiments of the present invention.

Though exemplary embodiments of the present invention are described with respect to rail vehicles, or railway transportation systems, specifically trains and locomotives having diesel engines, exemplary embodiments of the invention are also applicable for other uses, such as but not limited to off-highway vehicles (OHV), marine vessels, agricultural vehicles, and transport buses, each which may use at least one diesel engine, or diesel internal combustion engine. Towards this end, when discussing a specified mission, this includes a task or requirement to be performed by the diesel powered system. Therefore, with respect to railway, marine, transport vehicles, agricultural vehicles, or off-highway vehicle applications this may refer to the movement of the system from a present location to a destination. Likewise, operating conditions of the diesel-fueled power generating unit may include one or more of speed, load, fueling value, timing, etc. Furthermore, although diesel powered systems are disclosed, those skilled in the art will readily recognize that embodiments of the invention may also be utilized with non-diesel powered systems, such as but not limited to natural gas powered systems, bio-diesel powered systems, etc. Furthermore, as disclosed herein such non-diesel powered systems, as well as diesel powered systems, may include multiple engines, other power sources, and/or additional power sources, such as, but not limited to, battery sources, voltage sources (such as but not limited to capacitors), chemical sources, pressure based sources (such as but not limited to spring and/or hydraulic expansion), current sources (such as but not limited to inductors), inertial sources (such as but not limited to flywheel devices), gravitational-based power sources, and/or thermal-based power sources.

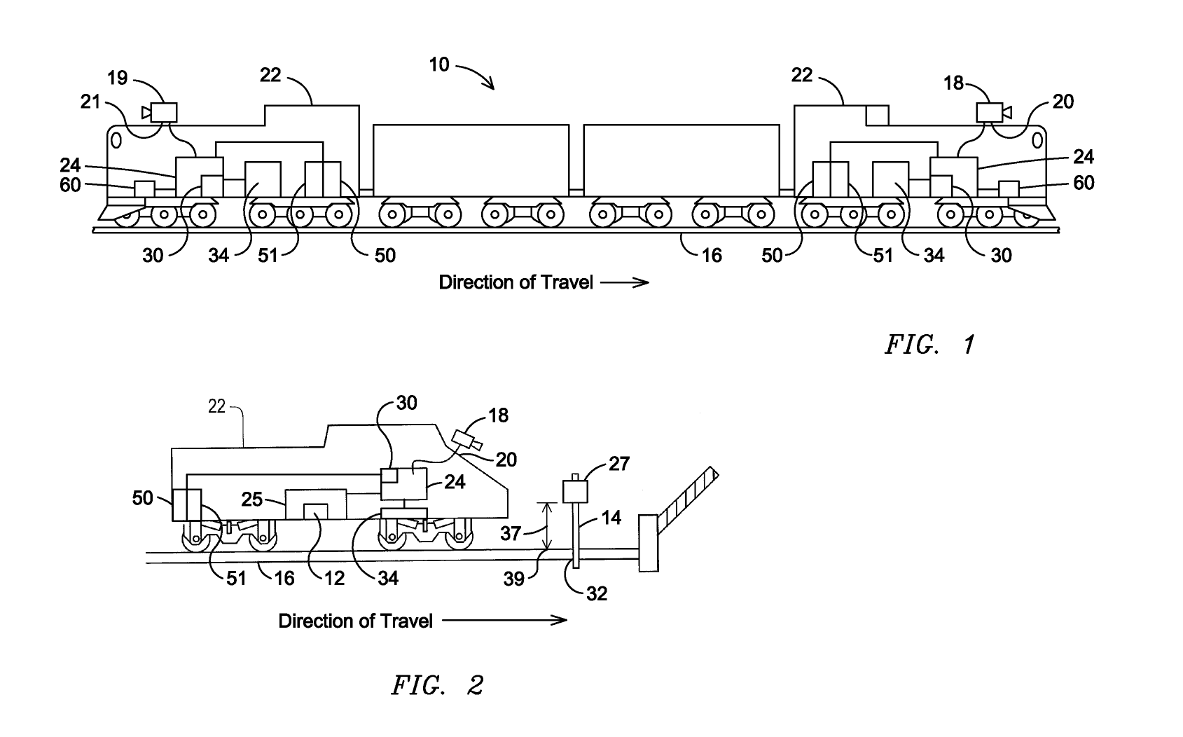

FIGS. 1-2 illustrate an embodiment of a system 10 for processing images 12 of wayside equipment 14 adjacent to a railroad 16. The system 10 includes a controller 24 within a locomotive 22. FIG. 1 illustrates a distributive power arrangement, in which two locomotives 22 are separated by a plurality of train cars, while FIG. 2 illustrates a single locomotive arrangement. The embodiments of the present invention discussed herein are not limited to either of the arrangements illustrated in FIGS. 1 and 2. A plurality of video cameras, such as a forward looking camera 18 and a rearward looking camera 19 are positioned on a respective front and rear external surface 20,21 of the locomotive 22. Although FIGS. 1-2 illustrate the cameras 18,19 being positioned on a respective external surface 20,21 of the locomotive 22, the cameras need not be positioned on an external surface of the locomotive, but instead may merely be attached to any portion of the locomotive 22, such as within a inner recess, for example. Each video camera 18,19 is configured to collect visible spectral data of the wayside equipment 14 as the locomotive 22 travels along the railroad 16. The controller 24 is coupled to the video camera 18 (FIG. 2), or alternatively, a respective controller 24 may be coupled to each video camera 18,19 (FIG. 1), to process the visible spectral data. Additionally, the controller 24 is configured to transmit a signal to a locomotive engine 50 based upon processing the visible spectral data, and this signal may be used to change the operating mode of the locomotive 22, as described below.

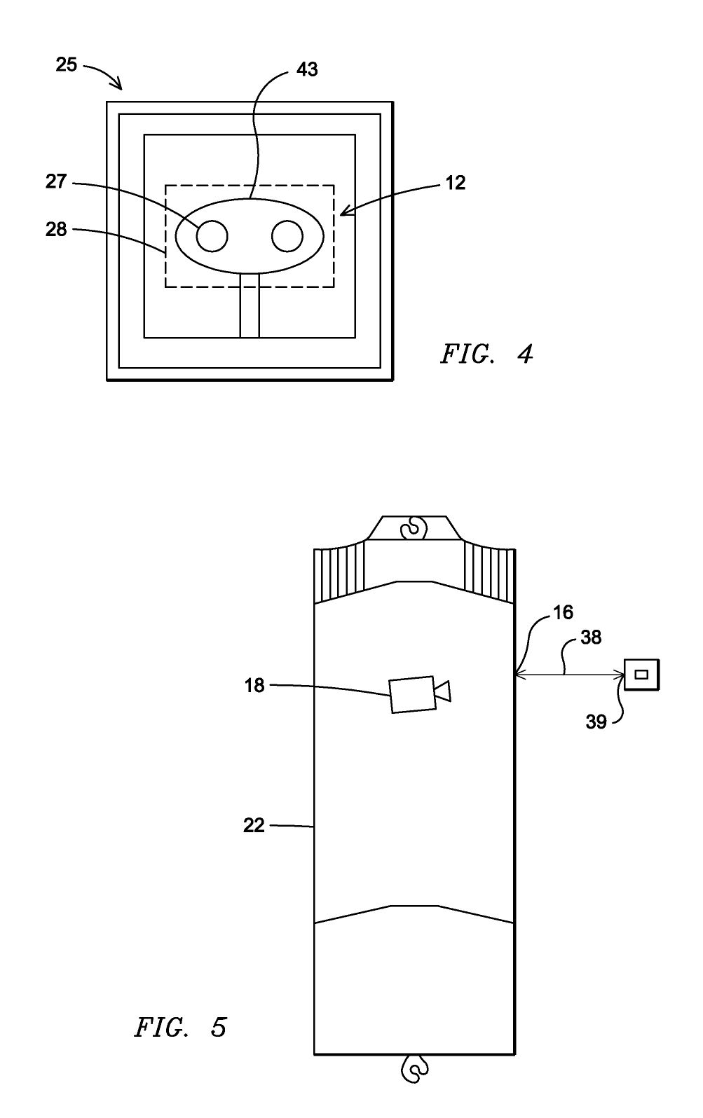

As illustrated in FIG. 2, the wayside equipment 14, whose spectral data is collected and processed by the video cameras 18,19 and controller 24, may be a light signal or a track number indicator for the locomotive 22, for example. For marine applications, the wayside equipment 14 may be a buoy, for example. For OHV, transport buses, and agricultural vehicles, the wayside equipment 14 may be a signal such as a light signal or a signal indicating a parameter of the route, for example. As illustrated in FIG. 4, a display 25 (FIG. 2) shows the images 12 of the wayside equipment 14 subsequent to the collection of spectral data from the wayside equipment 14 by the video cameras 18,19. Each video camera 18,19 may be configured to process pixels within an adjustable field of view 28 (see FIG. 4), where the adjustable field of view of the video camera is adjusted to coincide with some or all of the wayside equipment 14. For example, in the exemplary embodiment of FIG. 4, the adjustable field of view 28 of the video cameras 18,19 is adjusted such that the light signal portion 27 (FIG. 2) of the wayside equipment 14 is visible on the display 25.

Additionally, as illustrated in FIGS. 1-2, the controller 24 includes a memory 30 configured to store one or more expected positions 32 of the wayside equipment 14 along the railroad 16. For example, the memory 30 may store one or more distances for a particular track number from a fixed position, and thus the locomotive operator may retrieve these stored distances to determine the positions of the wayside equipment 14. Additionally, the memory 30 may store one or more position coordinates of the wayside equipment 14, and the system 10 may include a position determination device, such as a GPS (global positioning system) device, for example, coupled to the controller 24 to determine a position of the locomotive 22 along the railroad 16. (The GPS device may be one of several communications equipment components 34 carried on board the locomotive 22, for wireless communications or otherwise, including for example ISCS (International Satellite Communications System), satellite, cellular, and WLAN (wide local area network) components.) The controller 24 is configured to compare the stored position coordinates of the wayside equipment 14 with the present position of the locomotive 22 based on the GPS device or other position determination device. Once the locomotive 22 reaches the expected position 32 (or upon approaching the expected position 32) of the wayside equipment, the controller 24 arranges for the video cameras 18,19 to collect the visible spectral data of the wayside equipment 14. In collecting the visible spectral data of the wayside equipment 14, the field of view 28 (FIG. 4) of the video cameras 18,19 are adjusted to collect the visible spectral data of the wayside equipment 14 positioned at the expected position 32.

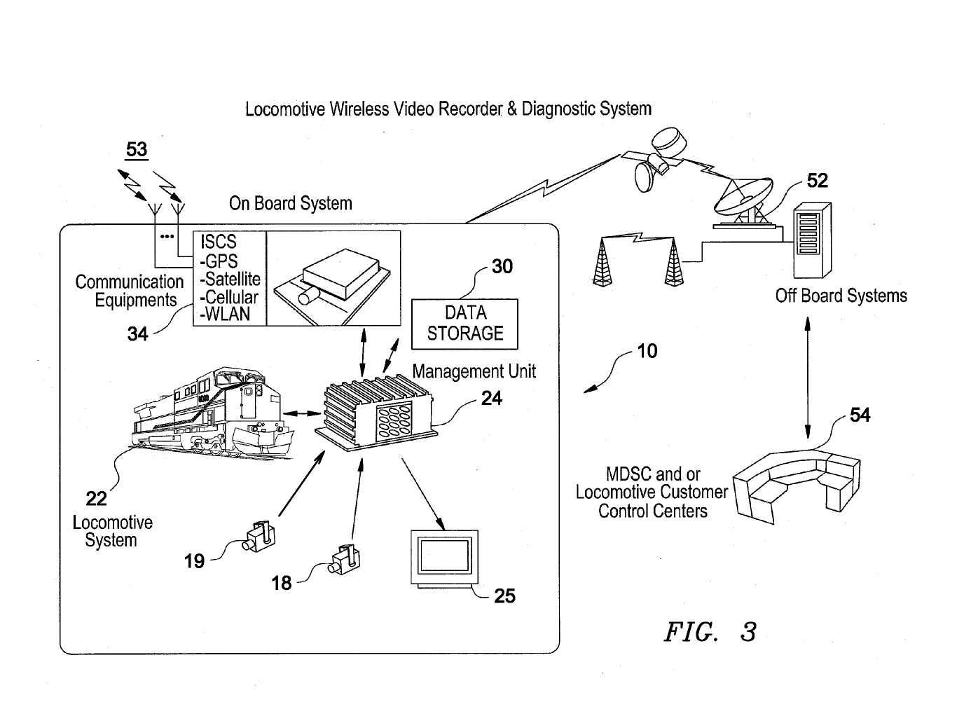

FIG. 3 illustrates an exemplary embodiment of a system 10 and the communications between the (on-board) system 10 and external devices, such as a satellite receiver 52 and/or a command center 54, for example. (As indicated in FIG. 3, the command center 54 may be, for example, a locomotive customer control center or a MDSC (Monitoring and Diagnostics Service Center). The satellite receiver 52 may provide position information of the locomotive 22 to a transceiver 53 on the locomotive 22, which is then communicated to the controller 24. The progress of the locomotive 22, in terms of properly processing spectral data of each wayside equipment 14 at each expected position 32 may be externally monitored (automatically or manually by staff) by the command center 54.

In an exemplary embodiment of the present invention, the memory or other data storage 30 may further store one or more position parameters of the wayside equipment 14 at each expected position 32. The field of view 28 is adjusted based upon the one or more stored position parameters to collect the visible spectral data of the wayside equipment 14 positioned at the expected position 32. As illustrated in FIG. 2, once the locomotive 22 reaches an expected position 32 of the wayside equipment 14, the controller 24 is configured to align the video cameras 18,19 with the wayside equipment 14 based upon on the position parameters. Examples of such position parameters include a perpendicular distance 37 from a ground portion 39 to the light signal portion 27 of the wayside equipment 14 (FIG. 2), and a perpendicular distance 38 from a portion of the railroad 16 to the ground portion 39 (FIG. 5).

When the wayside equipment 14 is a light signal, the memory 30 is configured to store an expected color of the light signal positioned at the expected position 32. Additionally, the memory 30 is configured to store an expected profile of the light signal frame 43 at the expected position 32 and is further configured to store an expected position of the wayside equipment 14, such as the light signal having the expected color along the light signal frame 43 (FIG. 4). For example, as illustrated in FIG. 4, the memory 30 may store information indicating that the light signal portion 27 of the wayside equipment 14, such as the light signal along the light signal frame 43, is a pair of centered light signals along the light signal frame 43.

In an exemplary embodiment, the signal generated by the controller 24 is based upon comparing the expected color stored in the memory 30 with a detected color of the wayside equipment 14, and the signal is configured to switch the locomotive 22 into one of a motoring mode and a braking mode. The motoring mode is an operating mode in which energy from a locomotive engine 50 or an energy storage device 51 (FIGS. 1-2) is utilized in propelling the locomotive 22 along the railroad 16, as appreciated by one of skill in the art. The braking mode is an operating mode in which energy from a locomotive engine 50 or locomotive braking system is stored in the energy storage device 51 (FIG. 2). Although the embodiments illustrated in FIGS. 1-2 involve the signal generated by the controller 24 being sent to the engine 50 to switch the locomotive 22 into the motoring mode or the braking mode, the controller 24 may transmit the signal to the engine 50 to reduce the power notch setting or limit the power notch setting of the engine 50, for example. In addition, the controller 24 may transmit the signal to the memory 30, to record each signal and thus the performance of the system 10, for subsequent analysis. For example, after the locomotive 22 has completed a trip, the controller 24 signals stored in the memory 30 may be analyzed to determine whether the system 10 was executed properly. In addition, the controller 24 may transmit the signal to other devices within the system 10 to generate different responses based on the processing of the visible spectral data. For example, the controller 24 may transmit the signal to an audible warning device 60, such as a horn, for example. As another example, the controller 24 may transmit the signal to a headlight of the locomotive 22. Thus, the controller 24 may transmit the signal to any device within the locomotive 22, to initiate an action based upon the processing of the visible spectral data from the wayside equipment 14, such as the light signal. In an exemplary embodiment, if the controller 24 determines that the color of the wayside equipment 14, such as the light signal does not correspond with the expected color of the wayside equipment 14, such as the light signal stored in the memory 30, the controller 24 may transmit a signal to the engine 50 to initiate the braking mode to slow down the locomotive 22 or transmit a signal to the audible warning device 60, to alert the operator of a possible dangerous condition, for example.

In the exemplary embodiment where the wayside equipment 14 is a light signal, the video cameras 18,19 are configured to process a plurality of frames of the light signal portion 27 to determine if the wayside equipment 14, such as the light signal, is in one of a flashing mode and non-flashing mode. For example, the video cameras 18,19 would generate a multiple set of images 12, as illustrated in FIG. 4, and determine whether or not the light signals are flashing or not. The flashing mode may be indicative of a particular upcoming condition along the railroad, such as a dangerous condition, for example. In the locomotive 22 cabin, a single operator may be used to operate the locomotive. As stated above, in an exemplary embodiment, in response to the controller 24 determining that the light signal or other wayside equipment 14 is in the flashing mode indicative of a dangerous condition, the controller may transmit the signal to the engine 50 to initiate the braking mode, the motoring mode, to modify or limit a power notch setting, or transmit the signal to the audible warning device 60, to alert the operator of a possible dangerous condition, for example.

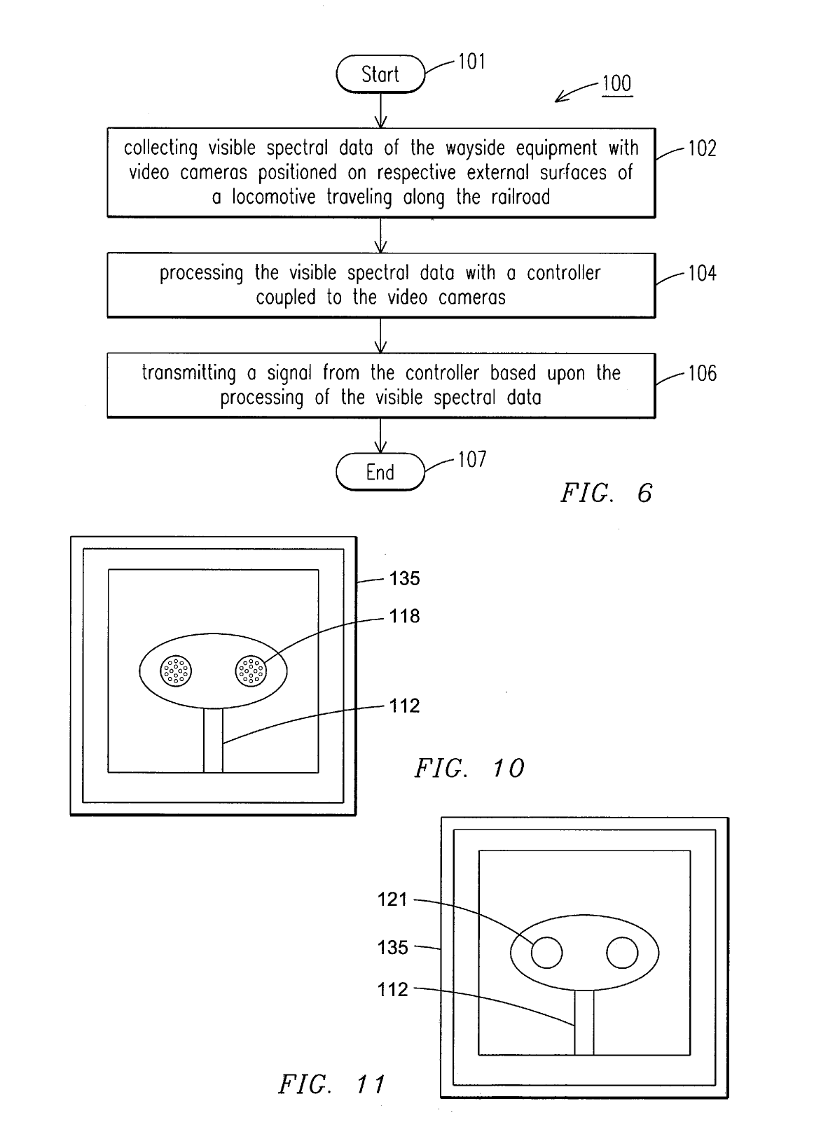

FIG. 6 illustrates an exemplary embodiment of a method 100 for processing images 12 of wayside equipment 14 adjacent to a railroad 16. The method 100 begins at 101 by collecting 102 visible spectral data of the wayside equipment 14 with video cameras 18,19 positioned on respective external surfaces 20,21 of a locomotive 22 traveling along the railroad 16. The method 100 further includes processing 104 the visible spectral data with a controller 24 coupled to the video cameras 18,19. The method 100 further includes transmitting 106 a signal from the controller 24 based upon processing of the visible spectral data, before ending at 107.

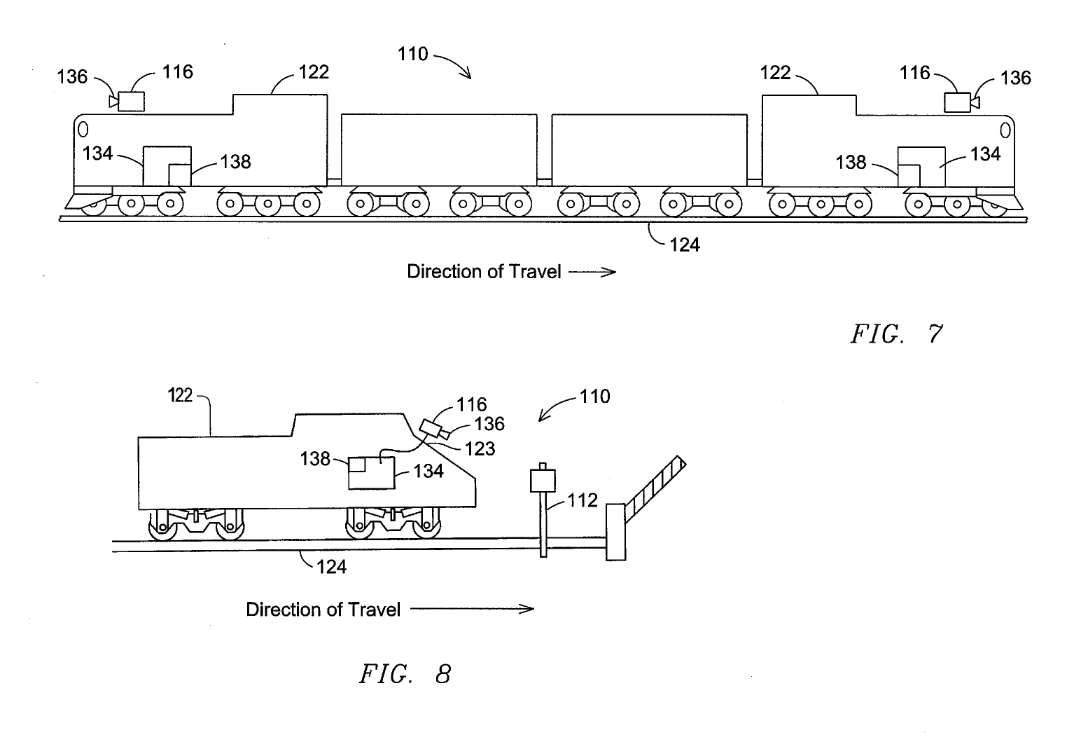

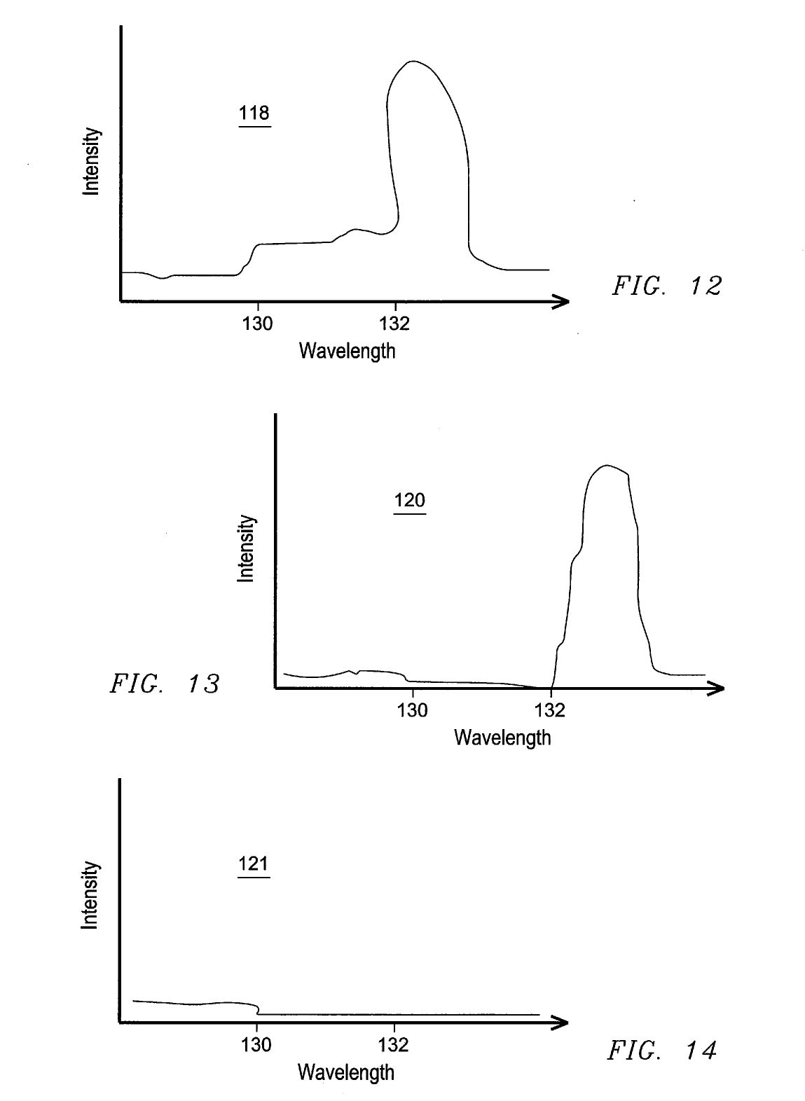

FIGS. 7-8 illustrate an exemplary embodiment of a system 110 for determining an informational property of wayside equipment 112 adjacent to a railroad 124. The system 110 includes a video camera 116 to collect visible spectral data 118,120,121 (FIGS. 12-14) of the wayside equipment 112. In the illustrated exemplary embodiment of FIG. 8, the video camera 116 is positioned on an external surface 123 of a locomotive 122 traveling along the railroad 124. As further illustrated in the exemplary embodiment of FIG. 8, the wayside equipment 112 is a light signal positioned adjacent to the railroad 124, and the system 110 may determine an informational property such as a color of the light signal, for example.

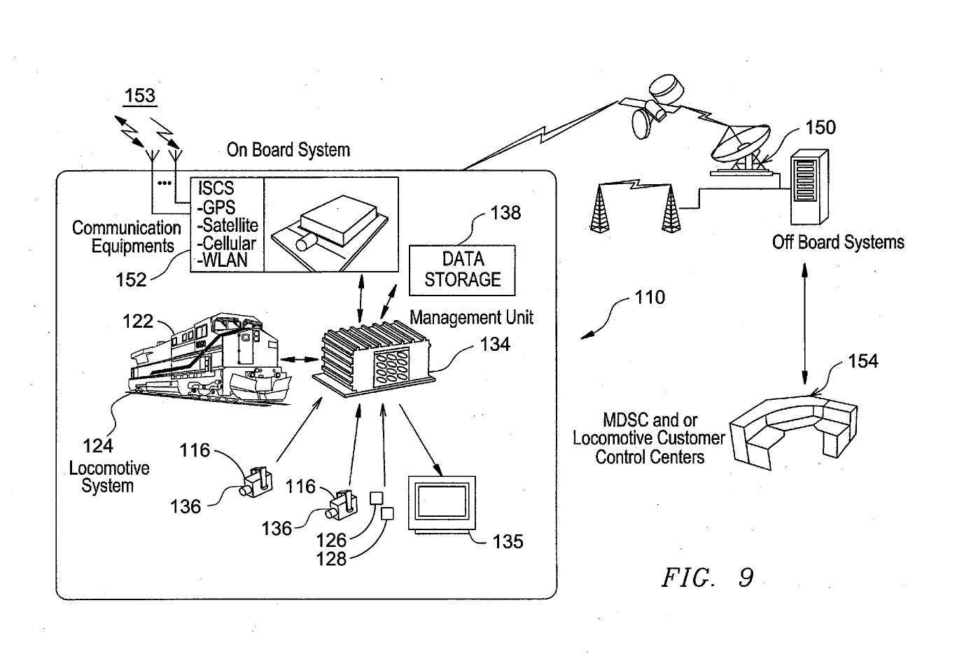

As further illustrated in FIG. 9, the system 110 includes a plurality of filters 126,128, where the filters 126,128 are configured to filter a known portion 130,132 (FIGS. 12-14) of the visible spectral data 118,120,121 based upon known properties of the filters 126,128. Upon positioning one or more of the filters 126,128, the filter(s) is/are positioned between a lens 136 of the video camera 116 and the wayside equipment 112, in order to ensure that spectral data from the wayside equipment 112 passes through the filter(s) 126,128, prior to entering the video camera 116. In the exemplary embodiment of FIG. 9, the filters 126,128 may be color filters configured to filter a respective known portion 130,132 (FIGS. 12-14) of the visible spectrum, based upon known properties of the color filter.

As further illustrated in the exemplary embodiment of FIGS. 8-9, a controller 134 is coupled to the video camera 116. The controller 134 is configured to compare unfiltered visible spectral data 118 (FIGS. 10,12), obtained prior to positioning the filters 126,128, with the filtered visible spectral data 120,121 (FIGS. 11, 13-14) obtained subsequent to positioning the filters 126,128. The controller 134 compares the unfiltered visible spectral data 118 and the filtered visible spectral data 120,121 in conjunction with the known properties of the filters 126,128 to determine the informational property of the wayside equipment 112, such as the color of a light signal, for example. The controller 134 may communicate this informational property of the wayside equipment 112 to an offboard system 150 using a wireless communication system 152 including one or more transceiver(s) 153, for example. The offboard system 150 may process the informational property of the wayside equipment 112, such as the colors of the light signals, and communicate this information to other locomotives in the vicinity of the locomotive 122, for example, or construct a real-time grid of the color indications of the light signals, for example, which would be accessible by all of the locomotive operators. Additionally, the offboard system 150 may share the informational properties of the wayside equipment 112 with a locomotive customer control center 154, which may ensure that the locomotive 122 abides by all safety precautions, for example.

The controller 134 is configured to store unfiltered visible spectral data 118 in a memory 138 prior to positioning the filters 126,128. Once the controller 134 compares the unfiltered visible spectral data 118 with the filtered spectral data 120,121, the controller 134 determines the color of the wayside equipment 112 light signal based upon a color of the unfiltered spectral data 118 being removed from the filtered spectral data 120,121. The color filters 126,128 are configured to filter a discrete respective known portion 130,132 of color within the visible spectral data based upon the known properties of the color filters 126,128. In the exemplary embodiment of FIGS. 10-14, the color filters 126,128 filter the discrete respective known portion 130,132 of green and red light within the visible spectral data, for example. However, the color filters may be configured to filter any discrete portion of the visible spectrum, and less than two or more than two color filters may be utilized in an exemplary embodiment of the system 110.

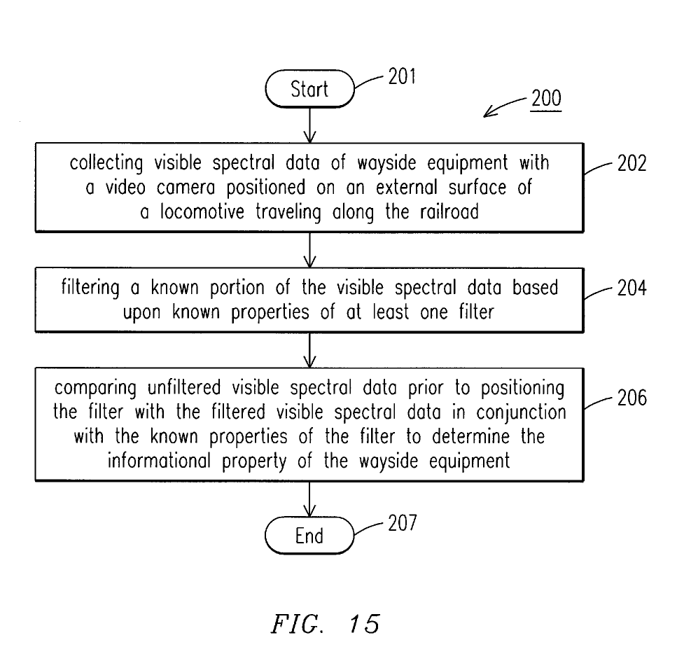

As illustrated in the exemplary embodiment of FIGS. 10-14, a display 135 illustrates an image of the wayside equipment 112 and the unfiltered spectral data 118 being emitted from the wayside equipment 112, such as a light signal, for example. The color filters 126,128 are individually consecutively positioned between the lens 136 and the wayside equipment 112 light signal until the filtered spectral data 121 has removed the color of the unfiltered spectral data 118 (FIG. 11). The controller 134 can determine the color of the wayside equipment 112 light signal and the unfiltered spectral data 118 by identifying the color of the filters 126,128 utilized to remove the color of the filtered spectral data 118. The controller 134 compares the unfiltered visible spectral data 118 with the filtered spectral data 120,121 for each respective individual filter 126,128. After the controller 134 recognizes the unfiltered spectral data 118 from the wayside equipment 112, without any color filters 126,128 positioned between the wayside equipment 112 and the lens 136 of the video camera 116, the controller 134 positions a color filter 126 between the wayside equipment 112 and the lens 136. The controller 134 may mechanically position a physical color filter, or electronically configure an electronic color filter to filter a discrete known portion 130 of the visible spectral data, for example. As discussed above, in the exemplary embodiment of FIGS. 10-14, the color filter 126 filters a discrete respective known portion 130 of green light within the visible spectral data. As a result, the filtered spectral data 120 (FIG. 13) subsequent to positioning the color filter 126 includes a noticeable decrease of intensity in the discrete known portion 130 of green light within the visible spectral data. The controller 134 compares the unfiltered spectral data 118 (FIG. 12) with the filtered spectral data 120 (FIG. 13), and determines if a common color or group of colors is present. In the exemplary embodiment, the controller 134 determines that the unfiltered spectral data 118 (FIG. 12) and filtered spectral data 120 (FIG. 13) include a common color of red, and thus the controller 134 positions a subsequent color filter 128 between the wayside equipment 112 and the lens 136 of the video camera 116. As discussed above, in the exemplary embodiment of FIGS. 10-14, the color filter 128 filters a discrete known portion 132 of red light within the visible spectral data. Upon positioning the color filter 128 between the wayside equipment 112 and the lens 136, the controller 134 compares the unfiltered spectral data 118 (FIG. 12) and the filtered spectral data 121 (FIG. 14). Since the unfiltered spectral data 118 and the filtered spectral data 121 do not include the common color of red found in the unfiltered spectral data 118, the controller 134 recognizes that the color of the unfiltered spectral data 118 coincides with the red color filter 128 which caused this red color to be removed in the filtered spectral data 121. Although the exemplary embodiment of FIGS. 10-14 discusses a red light signal as the wayside equipment 112, any color light signal may be utilized in conjunction with the system 110, and any type of color filters other than the green and red filters discussed above may be utilized.

FIG. 15 illustrates an exemplary embodiment of a method 200 for determining an informational property of wayside equipment 112 adjacent to a railroad 124. The method 200 begins at 201 by collecting 202 visible spectral data 118 of the wayside equipment 112 with a video camera 116 positioned on an external surface 123 of a locomotive 122 traveling along the railroad 124. The method 200 further includes filtering 204 a known portion 130,132 of the visible spectral data 118 based upon known properties of at least one filter 126,128. (As should be appreciated, and as described above, “known property” refers to a characteristic or configuration of the filter for filtering visible spectral data, as known to the system. Thus, for example, if the known property of a filter is to filter red light in a particular range of wavelengths, then the filter will filter light in that manner.) The method 200 further includes comparing 206 unfiltered visible spectral data 118 prior to positioning the filter 126,128 with the filtered visible spectral data 120,121 in conjunction with the known properties of the filter 126,128 to determine the informational property of the wayside equipment 112, before ending at 207.

Although certain embodiments of the present invention have been described above with respect to video cameras, other image capture devices could be used instead if capable of capturing visible spectral data for filtering/processing in the manner described above. As such, unless otherwise stated herein, the term “camera” collectively refers to video cameras and other image capture devices for capturing visible spectral data.

Additionally, although certain embodiments of the present invention have been described above with respect to video cameras mounted on external surfaces of a vehicle, the invention contemplates and encompasses any cameras capable of capturing visible spectral data originating from sources external to the vehicle (e.g., wayside signal lights), and which typically are adjustable in terms of viewing angle for capturing spectral data from equipment located at expected positions.

Based on the foregoing specification, the above-discussed embodiments of the invention may be implemented using computer programming or engineering techniques including computer software, firmware, hardware or any combination or subset thereof, wherein the technical effect is to determine an informational property of wayside equipment adjacent to a railroad. Any such resulting program, having computer-readable code means, may be embodied or provided within one or more computer-readable media, thereby making a computer program product, i.e., an article of manufacture, according to the discussed embodiments of the invention. The computer readable media may be, for instance, a fixed (hard) drive, diskette, optical disk, magnetic tape, semiconductor memory such as read-only memory (ROM), etc., or any emitting/receiving medium such as the Internet or other communication network or link. The article of manufacture containing the computer code may be made and/or used by executing the code directly from one medium, by copying the code from one medium to another medium, or by transmitting the code over a network.

One skilled in the art of computer science will easily be able to combine the software created as described with appropriate general purpose or special purpose computer hardware, such as a microprocessor, to create a computer system or computer sub-system of the method embodiment of the invention. An apparatus for making, using or selling embodiments of the invention may be one or more processing systems including, but not limited to, a central processing unit (CPU), memory, storage devices, communication links and devices, servers, I/O devices, or any sub-components of one or more processing systems, including software, firmware, hardware or any combination or subset thereof, which embody those discussed embodiments the invention.

This written description uses examples to disclose embodiments of the invention, including the best mode, and also to enable any person skilled in the art to make and use the embodiments of the invention. The patentable scope of the embodiments of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

That which is claimed is:

1. A system for determining an informational property of wayside equipment adjacent to a route, said system comprising:
a camera configured to collect visible spectral data of said wayside equipment, said camera being attached to a powered system traveling along said route;
at least one filter, said at least one filter being configured to filter a known portion of said visible spectral data based upon known properties of said filter; and
a controller coupled to said camera, said controller configured to compare unfiltered visible spectral data with said filtered visible spectral data, in conjunction with said known properties of said filter, to determine said informational property of said wayside equipment, wherein the unfiltered visible spectral data comprises the data collected by the camera prior to the at least one filter being applied thereto.

2. The system of claim 1, said camera being positioned on an external surface of said powered system, said powered system is one of an off-highway vehicle, a marine vehicle, a rail vehicle, a transport bus, and an agricultural vehicle.

3. The system of claim 1, wherein as said powered system travels along the route, said controller is configured to store unfiltered visible spectral data in a memory prior to said comparison of said unfiltered spectral visible data with said filtered visible spectral data.

4. The system of claim 3, wherein said wayside equipment is a light signal positioned adjacent to said route, said informational property is a color of said light signal, and said at least one filter is at least one color filter configured to filter a known color based upon known properties of said color filter.

5. The system of claim 4, wherein upon said controller comparing said unfiltered visible spectral data with said filtered spectral data, said controller is configured to determine said color of said light signal based upon a color of said unfiltered spectral data being removed from said filtered spectral data.

6. The system of claim 4, wherein said at least one filter comprises a plurality of filters, each filter being configured to filter a discrete known portion of color within said visible spectral data based upon said known properties of said filter.

7. The system of claim 6, wherein each filter of said plurality of filters is individually consecutively positioned between said lens and said light signal, said controller being configured to compare said unfiltered visible spectral data with said filtered spectral data for each individual filter.

8. The system of claim 7, wherein upon said controller having determined that said unfiltered visible spectral data and said filtered visible spectral data include a common group of colors, a subsequent filter is positioned between said lens and said light signal.

9. The system of claim 6, wherein said color filters include at least one of an electronic or a mechanical color filter.

10. A method for determining an informational property of wayside equipment adjacent to a route, said method comprising:
collecting visible spectral data of said wayside equipment with a camera attached to a powered system traveling along said route;
filtering a known portion of said visible spectral data based upon known properties of at least one filter; and
comparing unfiltered visible spectral data with said filtered visible spectral data in conjunction with said known properties of said filter to determine said informational property of said wayside equipment, said unfiltered visible spectral data comprising at least part of the visible spectral data collected by the camera prior to said filtering.

11. The method of claim 10, wherein said comparing is performed by a controller coupled to said camera, and further comprising:
positioning said at least one filter between a lens of said video camera and said wayside equipment, for filtering said known portion of said visible spectral data; and,
prior to positioning said at least one filter, storing said unfiltered visible spectral data in a memory of said controller.

12. The method of claim 10, wherein said wayside equipment is a light signal positioned adjacent to said route, said informational property is a color of said light signal, and said at least one filter is at least one color filter configured to filter a known color based upon known properties.

13. The method of claim 10, wherein upon said comparing said unfiltered visible spectral data with said filtered spectral data, said method further includes determining said color of said light signal based upon a color of said unfiltered spectral data being removed from said filtered spectral data.

14. The method of claim 12, wherein said at least one filter includes a plurality of filters, each filter being configured to filter a discrete known portion of color within said visible spectral data based upon said known properties.

15. The method of claim 10, further comprising individually consecutively positioning each filter of said plurality of filters between said lens and said light signal, wherein said comparing said unfiltered visible spectral data with said filtered spectral data is performed for each individual filter.

16. The method of claim 15, wherein upon determining that said unfiltered visible spectral data and said filtered visible spectral data include a common group of colors, a subsequent filter is positioned between said lens and said light signal.

17. The method of claim 10, wherein said filters include at least one of an electronic or a mechanical color filter.

18. Computer readable medium for determining an informational property of wayside equipment adjacent to a route, said computer readable medium comprising computer program code that when executed by a controller causes the controller:
to receive visible spectral data of wayside equipment collected by a camera attached to a powered system traveling along said route, said camera being connected to the controller, wherein a known portion of said visible spectral data is filtered based upon known properties of at least one filter, and wherein at least part of said collected visible spectral data is maintained as unfiltered data; and
to compare the unfiltered visible spectral data with said filtered visible spectral, in conjunction with said known properties of said filter, to determine said informational property of said wayside equipment.
